(19) United States
(12) Patent Application Publication
(10) Pub. No.: US 2015/0046031 A1
(43) Pub. Date: Feb. 12, 2015

(54) Switchable Mount System For A Vehicle And Methods For Controlling The System

(71) Applicant: Honda Motor Co., Ltd., Tokyo (JP)

(72) Inventors: Charles J. Gagliano, Hilliard, OH (US); Hajime Igami, Utsunomiya-city (JP); Daniel S. McCain, Hilliard, OH (US); John Louis Kern, Marysville, OH (US); Christopher L. Steinmeyer, Hilliard, OH (US); Stephen D. Ebert, New Albany, OH (US); Dennis J. Plank, Columbus, OH (US)

(73) Assignee: Honda Motor Co., Ltd., Tokyo (JP)

(21) Appl. No.: 13/961,052

(22) Filed: Aug. 7, 2013

(51) Int. Cl. B60G 17/015; B60G 13/06; B60G 17/08; B60K 5/12

(52) U.S. Cl. CPC B60G 17/0152; B60K 5/1283; B60G 13/06; B60G 17/08; B60G 2202/24; B60G 2204/62; B60G 2400/106; B60G 2400/204; B60G 2400/32; B60G 2500/10
USPC 701/37; 280/124.157

(57) ABSTRACT

A switchable mount system includes a switchable mount and an electronic control unit for switching the switchable mount between a first damping mode and a second damping mode. A method for controlling the switchable mount includes controlling the mount according to vehicle speed information, engine torque information, variable cylinder management information, and brake information. At least one of the damping modes may be tuned to damp vibrations approximately in the range approximately between 30 Hz and 60 Hz.

### BACKGROUND

The current embodiments relate to motor vehicles, and in particular to a switchable mount system for a vehicle suspension system as well as methods for controlling the system.

Vehicle suspension systems often include mounts, such as a hydraulic mount (e.g., a bushing) located on a component of the suspension system (e.g., on a lower suspension arm). The bushing is intended to dampen vibrations that would otherwise be transmitted through the suspension system. One source of such vibrations is engine vibrations (e.g., booming noise), which may occur, for example, when the engine is changing speeds or is operating on a reduced number of cylinders for fuel efficiency.

### SUMMARY

In one aspect, a method for controlling a switchable mount in a motor vehicle includes receiving a vehicle speed, receiving an engine torque, receiving a brake status, receiving a variable cylinder management operating mode, retrieving a predetermined engine torque and retrieving a predetermined vehicle speed. The method also includes comparing the vehicle speed with the predetermined engine speed and comparing the engine torque with the predetermined engine torque. The method also includes switching the switchable mount between a first damping mode and a second damping mode according to the brake status, the variable cylinder management operating mode, the comparison of the vehicle speed with the predetermined engine speed and the comparison of the engine toque with the predetermined engine torque. The first damping mode and the second damping mode are configured to damp substantially different ranges of frequencies.

In another aspect, a method for controlling a switchable mount in a motor vehicle includes receiving a vehicle speed. The method also includes retrieving a first predetermined vehicle speed and a second predetermined vehicle speed, where the second predetermined vehicle speed being greater than the first predetermined vehicle speed. The method also includes comparing the vehicle speed with the first predetermined vehicle speed and comparing the vehicle speed with the second predetermined vehicle speed. The method also includes switching the switchable mount between a first damping mode and a second damping mode according to the comparison of the vehicle speed with the first predetermined vehicle speed and the second predetermined vehicle speed. The first damping mode and the second damping mode are configured to damp substantially different ranges of frequencies.

In another aspect, a switchable mount system for a motor vehicle includes an electronic control unit configured to receive vehicle speed information, variable cylinder management information, engine torque information, and braking information. The switchable mount system also includes a switchable mount configured to operate in a first damping mode and a second damping mode. The electronic control unit is configured to change the switchable mount between the first damping mode and the second damping mode using the vehicle speed information, the variable cylinder management information, the engine torque information, and the braking information. The first damping mode and the second damping mode are substantially different.

In another aspect, a motor vehicle includes a component of a vehicle suspension system and a fluid-filled suspension bushing attached to the component of the vehicle suspension system. The suspension bushing is configured to damp vibrations having frequencies approximately in the range between 30 Hz and 60 Hz.

In another aspect, a switchable mount system for a motor vehicle includes an electronic control unit and a switchable mount configured to operate in a first damping mode and a second damping mode. The electronic control unit is configured to change the switchable mount between the first damping mode and the second damping mode. The first damping mode is configured to damp vibrations having frequencies approximately in the range between 0 Hz to 30 Hz and the second damping mode is configured to damp vibrations having frequencies approximately in the range between 30 Hz to 60 Hz.

Other systems, methods, features, and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following claims.

### BRIEF DESCRIPTION OF THE DRAWINGS

The embodiments can be better understood with reference to the following drawings and detailed description. The components in the figures are not necessarily to scale, emphasis instead being placed upon illustrating the principles of the embodiments. Moreover, in the figures, like reference numerals designate corresponding parts throughout the different views.

FIG. 1 is a schematic view of an embodiment of a switchable mount system for a motor vehicle;

FIG. 2 is an isometric view of an embodiment of a switchable mount attached to a portion of a suspension assembly;

FIG. 3 is a view of an embodiment of a switchable mount in a first mode;

FIG. 4 is a view of an embodiment of a switchable mount in a second mode;

FIG. 5 illustrates a schematic view of an embodiment of different frequency ranges for damping vibrations using a mount;

FIG. 6 is an embodiment of a process for operating a control valve in a switchable mount;

FIG. 7 is an embodiment of a process for operating a switchable mount in which the process distinguishes between variable cylinder management on and off modes;

FIG. 8 is an embodiment of a table showing how the damping mode of a switchable mount changes with different operating parameters;

FIG. 9 is an embodiment of a process for operating a switchable mount in which the process distinguishes between three different cylinder management modes;

FIG. 10 is an embodiment of a table showing how the damping mode of a switchable mount changes with different operating parameters;

FIG. 11 is an embodiment of a various predetermined speeds for use in operating a switchable mount; and

FIG. 12 is an embodiment of a process for operating a switchable mount that utilizes three different predetermined speeds.

### DETAILED DESCRIPTION

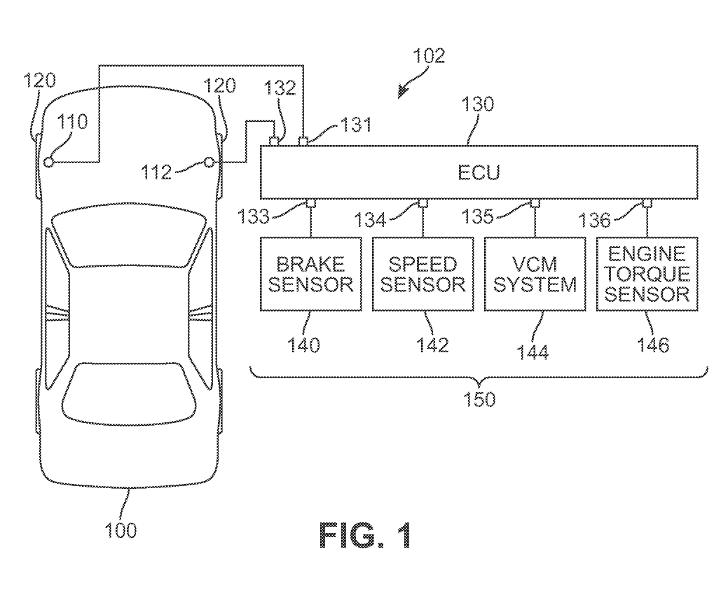

FIG. 1 is a schematic view of an embodiment of various components for a motor vehicle 100. The term “motor vehicle” as used throughout this detailed description and in the claims refers to any moving vehicle that is capable of carrying one or more human occupants and is powered by any form of energy. The term “motor vehicle” includes, but is not limited to: cars, trucks, vans, minivans, SUVs, motorcycles, scooters, boats, personal watercraft, and aircraft.

In some cases, a motor vehicle includes one or more engines. The term “engine” as used throughout the specification and claims refers to any device or machine that is capable of converting energy. In some cases, potential energy is converted to kinetic energy. For example, energy conversion can include a situation where the chemical potential energy of a fuel or fuel cell is converted into rotational kinetic energy or where electrical potential energy is converted into rotational kinetic energy. Engines can also include provisions for converting kinetic energy into potential energy. For example, some engines include regenerative braking systems where kinetic energy from a drive train is converted into potential energy. Engines can also include devices that convert solar or nuclear energy into another form of energy. Some examples of engines include, but are not limited to: internal combustion engines, electric motors, solar energy converters, turbines, nuclear power plants, and hybrid systems that combine two or more different types of energy conversion processes.

For purposes of clarity, only some components of motor vehicle 100 are shown in the current embodiment. Furthermore, it will be understood that in other embodiments some of the components may be optional. Additionally, it will be understood that in other embodiments, any other arrangements of the components illustrated here can be used for powering motor vehicle 100.

Motor vehicle 100 can include one or more mounts that can help facilitate damping of vibrations that may be otherwise transmitted through the suspension system of motor vehicle 100. In some cases, a mount can be a switchable mount that provides for damping in two or more frequency ranges. For example, a mount can be configured to damp engine booming vibrations, which are relatively high frequency vibrations, as well as low frequency vibrations such as shimmy and/or judder vibrations.

In some embodiments, motor vehicle 100 can include switchable mount system 102, also referred to simply as system 102. Switchable mount system 102 can comprise one or more switchable mounts. In some cases, system 102 includes first switchable mount 110 and second switchable mount 112. First switchable mount 110 and second switchable mount 112 could be any type of mounts including, but not limited to bushings and/or other kinds of vibration isolators. In one embodiment, first switchable mount 110 and second switchable mount 112 may both be switchable control bushings. However, in other embodiments, first switchable mount 110 or second switchable mount 112 may not be switchable bushings.

The location of one or more mounts can vary in different embodiments. In some cases, a mount can be associated with a connection between a frame of a vehicle and a sub frame. In other cases, a mount can be associated with a connection between a sub frame and an engine. In one embodiment, one or more mounts can be associated with a lower control arm of a suspension system. For example, in one embodiment, first switchable mount 110 can be associated with left front wheel 120 and second switchable mount 112 can be associated with right front wheel 122. In particular, each mount can be associated with a control arm of a suspension system as discussed in further detail below. For example, each mount can be used to connect a portion of a control arm with a portion of a sub-frame assembly. However, in other embodiments, first switchable mount 110 and second switchable mount 112 could be disposed in any other portion of a motor vehicle.

In some embodiments, only two mounts may be used with system 102. However, other embodiments can include additional mounts that are switchable and/or static mounts that are not switchable. For example, in another embodiment, system 102 can include four switchable mounts associated with each of the wheels of vehicle 100.

System 102 can include provisions for controlling first switchable mount 110 and second switchable mount 112. In some embodiments, system 102 can include electronic control unit 130, also referred to as ECU 130. In some cases, ECU 130 may include a microprocessor, RAM, ROM, and software all serving to monitor and supervise various parameters of motor vehicle 100. For example, ECU 130 is capable of receiving signals from numerous sensors located in motor vehicle 100. The output of various sensors is sent to ECU 130 where the sensor signals may be stored in an electronic storage, such as RAM. Both current and electronically stored sensor signals may be processed by a central processing unit (CPU) in accordance with software stored in an electronic memory, such as ROM. In some cases, ECU 130 may be an application specific integrated circuit (ASIC), an electronic circuit, a processor (shared, dedicated, or group) and memory that executes one or more software or firmware programs, a combinational logic circuit, a computer, and/or other suitable components that provide the described functionality.

In some embodiments, ECU 130 may be associated with an onboard computer of motor vehicle 100. In some cases, ECU 130 could be part of an onboard diagnostics computer that monitors various kinds of operating information. In other cases, however, ECU 130 could be associated with a stand-alone or external control unit that controls system 102. In such cases, ECU 130 could receive various kinds of vehicle operating information from another system, such as an onboard diagnostics system or other onboard unit. For example, in some cases, ECU 130 may comprise a control unit that is installed in a vehicle separately from an onboard unit that monitors and/or controls other vehicle systems. This may allow system 102 to be installed at any time during, and in some cases after, the manufacturing of vehicle 100. Although the current embodiment illustrates ECU 130 as well as other components as external to vehicle 100, it should be understood that this is only for purposes of illustration and the location of ECU 130 as well as any other components could be disposed in any portion of motor vehicle 100.

ECU 130 can include a number of ports that facilitate the input and output of information and power. The term “port” means any interface or shared boundary between two conductors. In some cases, ports can facilitate the insertion and removal of conductors. Examples of these types of ports include mechanical connectors. In other cases, ports are interfaces that generally do not provide easy insertion or removal. Examples of these types of ports include soldering or electron traces on circuit boards.

The following ports and provisions associated with ECU 130 are generally optional. Some configurations may include a given port or associated provision, while others may exclude it. The following description discloses many of the possible parts and provisions that can be used; however, it should be kept in mind that not every part or provision must be used in a given configuration.

ECU 130 can include provisions for transmitting signals to, and in some cases receiving signals from, first switchable mount 110 and second switchable mount 112. In some cases, ECU 130 can include port 131 and port 132 for communicating with first switchable mount 110 and second switchable mount 112, respectively. With this configuration, ECU 130 can provide control signals to first switchable mount 110 and/or second switchable mount 112. In some cases, ECU 130 could also receive any kind of signals from first switchable mount 110 and/or second switchable mount 112 using port 131 and port 132, respectively.

In some embodiments, ECU 130 can include provisions for receiving braking information. In some cases, ECU 130 can include port 133 for receiving braking information. In some cases, port 133 can receive braking information from brake sensor 140.

In some embodiments, brake sensor 140 may monitor the status of the brakes of a vehicle and determine whether the brakes are being applied, i.e., whether the brakes are on or off. Brake sensor 140 may, for example, detect the ON-OFF condition of a brake switch and generate a brake status signal dependent on the ON-OFF condition. Brake sensor 140 may output the signal to ECU 130. In other embodiments, brake sensor 140 could detect the amount of braking, rather than, or in addition to, an ON-OFF condition. Examples of different brake sensors are known in the art and include, but are not limited to: piezoelectric sensors, strain-gauge sensors, pressure sensors, position and/or angle sensors, switch sensors as well as any other kinds of sensors.

In some embodiments, ECU 130 can include provisions for receiving vehicle speed information. In some cases, ECU 130 can include port 134 for receiving vehicle speed information. In some cases, ECU 130 can communicate with speed sensor 142 using port 134. In some cases, speed sensor 142 can be a vehicle speed pulse sensor associated with a transmission of motor vehicle 100. In other cases, speed sensor 142 can be any other type of sensor configured to provide vehicle speed information to one or more systems of motor vehicle 100. For example, in some cases, speed sensor 142 could comprise one or more wheel speed sensors that sense the speed of one or more wheels, rather than transmission speed. By monitoring information received from speed sensor 142, ECU 130 may be configured to determine the current vehicle speed of motor vehicle 100.

In some embodiments, ECU 130 can include provisions for receiving information related to a variable cylinder condition of an engine. In some cases, ECU 130 can include port 135 for receiving information from variable cylinder management system 144, also referred to as VCM system 144. VCM system 144 may be configured to operate the engine of vehicle 100 in various cylinder modes. A VCM system may be a fuel-saving control system that automatically deactivates cylinders of an engine based on driving conditions. In one embodiment, a VCM system installed on a six-cylinder engine may deactivate ⅓ or ½ of the cylinders, thereby switching between six-, four-, and three-cylinder combustion, as necessary to accommodate varying driving conditions. For example, six-cylinder combustion may be used for hard acceleration, four-cylinder combustion may be used for moderate acceleration, and three-cylinder combustion may be used during high-speed cruising, deceleration, and braking. The VCM system shuts off the intake and exhaust valves and halts fuel supply in two cylinders when ⅓ of the cylinders are deactivated and in three cylinders when ½ of the cylinders are deactivated. In some cases, the VCM system 144 may generate a variable cylinder mode signal corresponding to the reduced cylinder mode in which the engine is operating. For example, in a six-cylinder engine having two reduced cylinder modes (four-cylinder and three-cylinder modes), VCM system 144 may be capable of generating three different VCM status signals, one signal corresponding to a six-cylinder mode when the VCM system is off, one signal corresponding to a four-cylinder mode when the VCM system is on, and one signal corresponding to a three-cylinder mode when the VCM system is on. VCM system 144 may output the VCM status signals to ECU 130. Alternatively, a separate sensor or other device may detect the status of the VCM system and generate and output a corresponding status signal to ECU 130.

In some embodiments, ECU 130 can include provisions for receiving engine torque information. In some cases, ECU 130 can include port 136 for receiving engine torque information. In some cases, ECU 130 can receive information from engine torque sensor 146 using port 136. Engine torque sensor 146 can be any kind of torque sensor known in the art. In some cases, engine torque sensor 146 may detect the torque of a vehicle engine and may generate a signal corresponding to the value of the engine torque. This signal can be transmitted to ECU 130 through port 136.

For purposes of clarity, brake sensor 140, speed sensor 142, VCM system 144 and engine torque sensor 146 may be referred to collectively as components 150. In some cases, components 150 may output data signals to ECU 130 at predetermined intervals suitable for monitoring and adjusting the operation of first switchable mount 110 and/or second switchable mount 112. For example, ECU 130 may process the data signals and adjust first switchable mount 110 and/or second switchable mount 112 every 10 milliseconds, in which case the output data signals may be sent by components 150 every 10 milliseconds, or at shorter intervals. Components 150 may be configured to output the data signals automatically, or alternatively, may be configured to output the data signals in response to request signals from ECU 130.

Although FIG. 1 shows components 150 as separate devices, two or more of the devices may be part of a single device. In addition, there may be additional devices in between components 150 and ECU 130, which for example, compile the vehicle operating data and forward it to ECU 130. For example, a central processing unit of the vehicle may receive and compile the data from components 150, and forward that data to ECU 130.

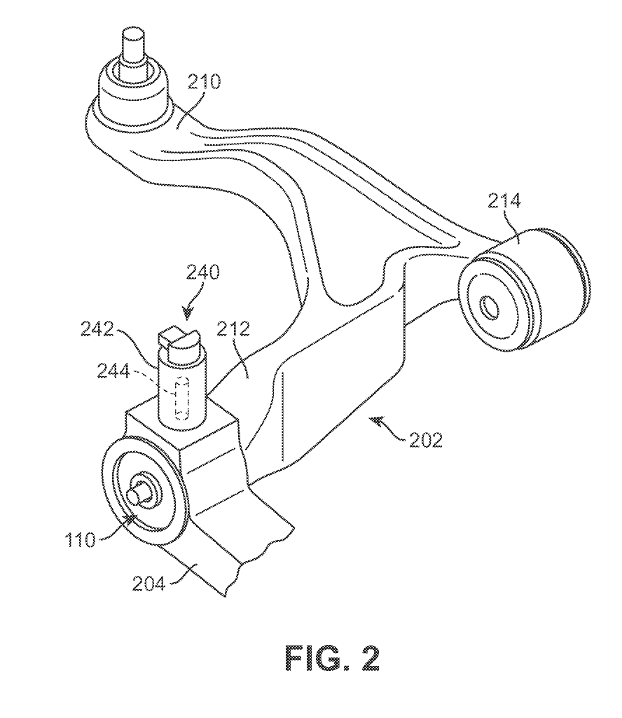

FIG. 2 illustrates an isometric view of one embodiment of first switchable mount 110. Although the following discussion describes the structure and operation of first switchable mount 110 in detail, it will be understood that the structure and operation of second switchable mount 112 can be substantially similar to first switchable mount 110.

In one embodiment, as shown in FIG. 2, switchable mount 110 may be a bushing located within a vehicle suspension, such as on lower suspension arm 202. Moreover, switchable mount 110 may connect suspension arm 202 with frame portion 204 of vehicle 100 (see FIG. 1). Frame portion 204 could be any portion of a frame assembly or sub-frame assembly of vehicle 100. Using this configuration, switchable mount 110 may provide a means for damping vibrations that would otherwise be transmitted between suspension arm 202 and frame portion 204. In other cases, however, switchable mount 110 may be associated with any other suspension component or any other component of a frame assembly or frame sub-assembly. For example, in another embodiment, switchable mount 110 could be used to mount an engine to a frame or sub-frame assembly.

In some embodiments, suspension arm 202 includes first portion 210 and second portion 212. First portion 210 may be further associated with suspension components and may be located proximate to a wheel in some cases. Second portion 212 is attached to switchable mount 110, which further connects with frame portion 204. In addition, a third portion 214 of suspension arm 202 can be connected to additional vehicle components, including other portions of a frame assembly or sub-assembly.

In some embodiments, switchable mount 110 may be a fluid-operated mount (e.g., pneumatically or hydraulically controlled). In some cases, switchable mount 110 may have switchable damping characteristics for adjusting its vibration damping properties between multiple ranges of frequencies. In other words, the compliance characteristics of the switchable mount may be adjusted to different settings. An exemplary switchable mount is the hydraulic mount disclosed in Loheide et al., U.S. Pat. No. 7,694,945, filed Mar. 7, 2007, the entirety of which is hereby incorporated by reference.

Switchable mount 110 may be further associated with control valve unit 240. Control valve unit 240 includes valve housing 242 and valve 244 (shown in phantom). In some cases, control valve unit 240 is mounted to switchable mount 110 in order to control the damping characteristics of switchable mount 110. In some embodiments, control valve unit 240 uses an electromagnet to actuate valve 244. In other embodiments, however, valve 244 can be actuated in any other manner. Moreover, in some cases, control valve unit 240 may be operated in response to control signals from ECU 130 (see FIG. 1).

With this configuration, control valve unit 240 may regulate the fluid delivered through fluid lines to the switchable mount 110. Optionally, ECU 130 may control switchable mount 110 by means other than fluid, in which case control valve unit 240 may be omitted or replaced with a control device suitable for the control means.

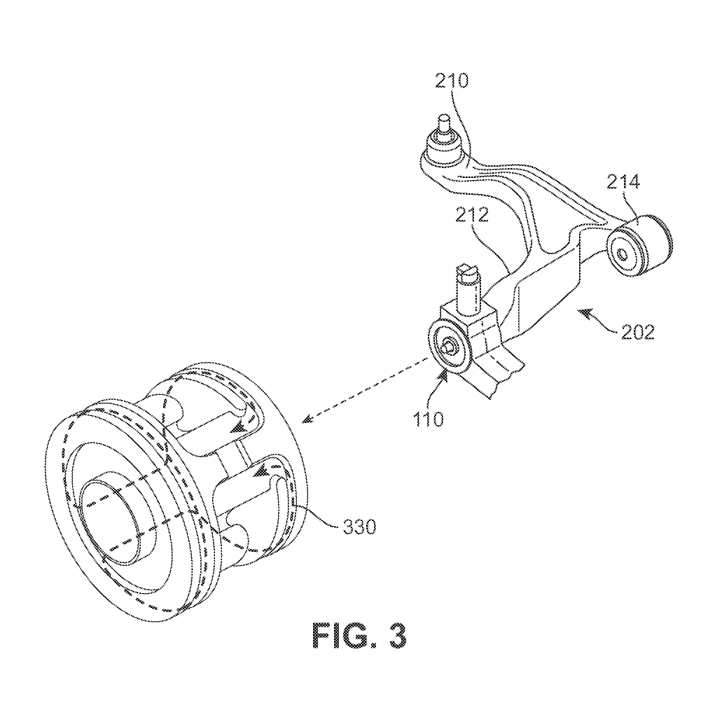

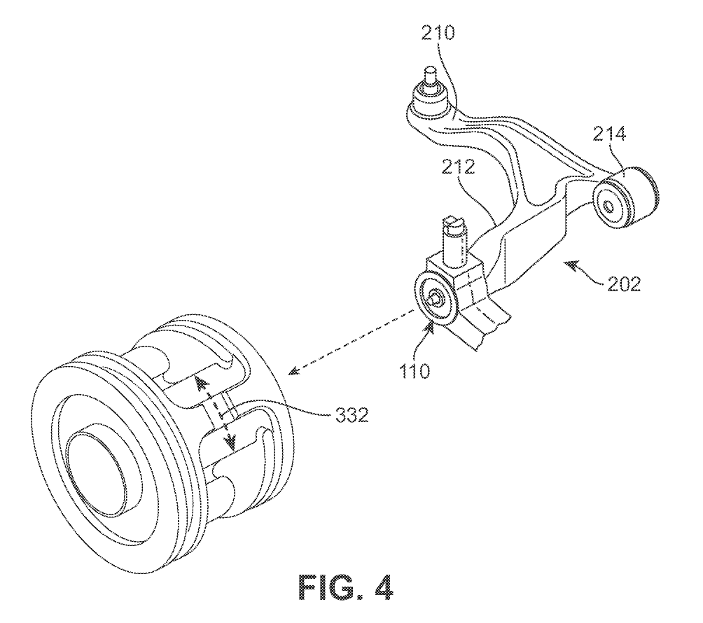

FIGS. 3 and 4 are views of an embodiment of the operation of switchable mount 110 in two different operating modes. In a first damping mode, shown in FIG. 3, switchable mount 110 may operate to damp vibrations caused by forces input by a wheel and/or brake at first portion 210 of suspension arm 202. These vibrations, also referred to as shimmy and judder, can be felt by a driver under circumstances where the forces are not damped. In this situation, forces applied by the wheel act to shake first portion 210, which further causes second portion 212 to shake or rock. Specifically, second portion 212 may pivot about third portion 214.

To dampen this kind of large amplitude and low frequency vibration, switchable mount 110 may be operated in the first damping mode, also referred to as the low frequency mode or shimmy/judder mode. In the first damping mode, valve 244 may be positioned such that fluid travels between opposing sides of switchable mount 110 along a long flow channel 330. This allows switchable mount 110 to operate as a hydraulic “mass damped” system and provides damping in the low frequency range to counter the shimmy and judder effects transmitted by the wheel.

In a second damping mode, shown in FIG. 4, switchable mount 110 may operate to damp vibrations caused by forces input by a driveshaft at first portion 210 of suspension arm 202. These vibrations, which may be associated more generally with noise, vibration, and harshness (NVH), can be felt by a driver under circumstances where the forces are not damped. In this situation, forces applied by the driveshaft act to vibrate first portion 210, which further causes vibration of suspension arm 202. In some cases, second portion 212 may vibrate in response to the vibration of first portion 210.

To dampen this kind of small amplitude and high frequency vibration, switchable mount 110 may be operated in the second damping mode, also referred to as the high frequency mode or NVH mode. In the second damping mode, valve 244 may be positioned such that fluid travels between opposing sides of switchable mount 110 along a short flow channel 332, which is shorter than the long flow channel 330 as shown in FIG. 3. This allows switchable mount 110 to operate as a hydraulic “friction damped” system and provides damping in the high frequency range to counter the NVH vibrations transmitted by the driveshaft.

In different embodiments, the first damping mode and the second damping mode of switchable mount 110 could be associated with any ranges of frequencies. For example, in some cases, the first damping mode may be associated with a low frequency range. In some cases, the first damping mode could be configured to damp vibrations approximately in the range between 0 Hz and 30 Hz. In other cases, the first damping mode could be configured to damp vibrations approximately in the range between 0 Hz and 20 Hz. In one embodiment, the first damping mode could be configured to damp vibrations approximately in the range between 10 Hz and 20 Hz. Moreover, in some embodiments, the second damping mode may be associated with a high frequency range. In some cases, the second damping mode could be configured to damp vibrations approximately above 30 Hz. In some cases, the second damping mode could be configured to dampen vibrations approximately in the range between 30 Hz and 60 Hz. In one embodiment, the second damping mode could be configured to damp vibrations approximately in the range between 40 Hz and 50 Hz. It will be understood that the frequency damping ranges for the first damping mode and the second damping mode discussed here are only intended to be exemplary and in other embodiments each mode could be tuned to dampen any other range of frequencies.

It will be understood that any method of tuning a switchable mount to damp a particular frequency or range of frequencies in either the first or second damping mode can be used. In particular, any of the physical characteristics of the switchable mount used to achieve damping can be adjusted to tune the damping range. In some cases, achieving damping in a desired frequency range may correspond to tuning the mount to have a peak damping frequency in the desired frequency range. In some cases, the desired frequency range for damping corresponds to a range within which to tune a C peak frequency for the mount. Moreover, the physical characteristics of the switchable mount can be changed to adjust the damping characteristics in order to switch the mount between two different damping modes.

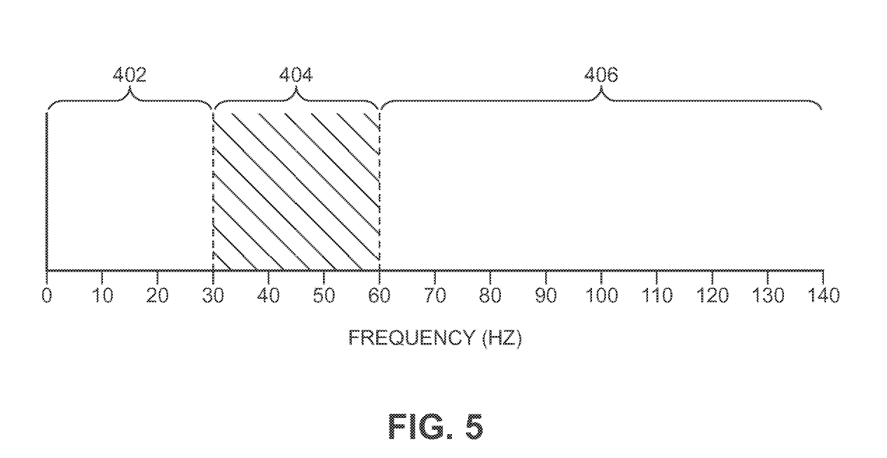

FIG. 5 illustrates a schematic view of an embodiment of a chart indicating different ranges of frequencies. Referring to FIG. 5, low frequency range 402 corresponds to frequency ranges between approximately 0 Hz and 30 Hz and may correspond to vibrations in a vehicle due to shimmy, judder, and don-giku (shift shock or jerkiness). Intermediate frequency range 404 corresponds to frequency ranges between approximately 30 Hz and 60 Hz and may correspond to vibrations in a vehicle such as engine booming vibrations, or other common sources of NVH, especially during the operation of a variable cylinder management system in an engine. High frequency range 406 corresponds to frequency ranges greater than approximately 60 Hz. In some cases, a bushing may be tuned to damp frequencies in the low frequency range 402. In other cases, a bushing may be tuned to damp frequencies in the intermediate frequency range 404. In still other cases, a bushing may be tuned to damp frequencies in the high frequency range 406.

In some embodiments, a bushing can be tuned to reduce vibrations in multiple different frequency ranges. For example, in the embodiment discussed above, a switchable bushing could be configured to damp vibrations in both the low frequency range 402 as well as the intermediate frequency range 404. In some cases, for example, a switchable bushing could operate in a first damping mode to damp vibrations in the range between approximately 10 Hz and 20 Hz. The switchable bushing could also operate in a second damping mode to damp vibrations in the range between approximately 30 Hz and 60 Hz.

It will be understood that in some embodiments, a mount could be configured to damp a single range of frequencies. In other words, the mount may not be a switchable mount in all embodiments. In some cases, for example, the mount could comprise a fluid-filled suspension bushing that is tuned to damp frequencies approximately in the intermediate frequency range 404, including frequencies approximately between 30 Hz and 60 Hz. In some cases, the bushing could be configured to dampen frequencies approximately in the range between 40 Hz and 50 Hz. This allows a bushing to be used for purposes of damping various sources of vibrations in the 30 Hz to 60 Hz range, including engine booming vibrations as well as other sources.

Switchable mount system 102 may adjust the compliance characteristics of switchable mount 110 based on data received concerning the operating conditions of the vehicle. In some cases, the data may include brake status, vehicle speed, variable cylinder management system status, and engine torque. In other cases, any other kind of vehicle operating information could also be used to adjust the characteristics of switchable mount 110, including, but not limited to: yaw rate information, lateral g information, steering angle information, engine speed information, transmission information, as well as any other kinds of vehicle operating information.

As previously discussed and shown in FIG. 1, in the following embodiments, ECU 130 may be in communication with at least brake sensor 140, speed sensor 142, VCM system 144, and engine torque sensor 146. Having received the vehicle operation data signals from various input devices, ECU 130 may execute control logic that adjusts the switchable mount 110 based on the vehicle operation data signals, as discussed in further detail below. To execute that control logic, ECU 130 may store predetermined values of vehicle operating conditions and compare those predetermined values against the vehicle operation data signals from components 150. The stored predetermined values may be pre-programmed in memory of ECU 130 or may be input separately, and changed as desired, by a user.

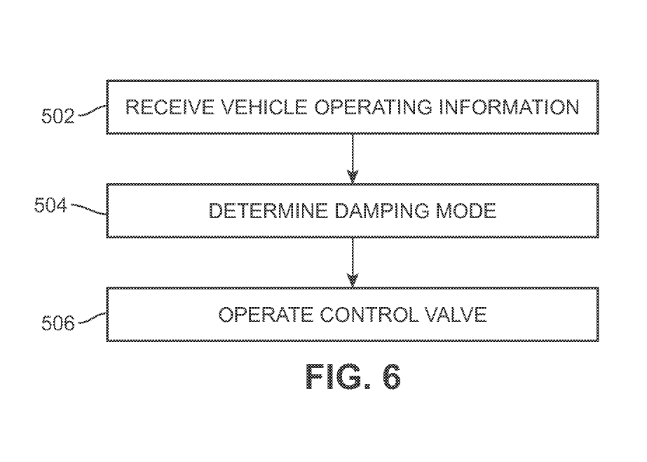

FIGS. 6-8 illustrate embodiments of various processes for controlling a switchable mount system. In some embodiments, some of the steps associated with each process could be accomplished by switchable mount system 102 of a motor vehicle. In some cases, some of the steps may be accomplished by an ECU 130 of a motor vehicle. In other embodiments, some of the steps could be accomplished by other components of a motor vehicle. In still other embodiments, some of the steps could be accomplished by any combination of systems or components of the vehicle. It will be understood that in some embodiments one or more of the steps associated with the processes may be optional. For purposes of reference, the following methods discuss components shown in FIG. 1, including components 150.

FIG. 6 illustrates an embodiment for a general process for controlling a switchable mount system. In step 502, ECU 130 may receive vehicle operating information. As previously discussed, the vehicle operating information can include brake status, vehicle speed, variable cylinder management system status, and engine torque, as well as other kinds of vehicle operating information. Moreover, in some cases, the vehicle operating information can be received from components 150, as well as any other sensors or components associated with motor vehicle 100.

In step 504, ECU 130 may determine a damping mode. In some embodiments, the damping mode is determined according to the various values of the different operating parameters. Embodiments of a method for determining the damping mode are discussed in further detail below. Following step 504, in step 506, ECU 130 may operate a control valve associated with switchable mount system 102. In particular, the control valve could be positioned according to the type of damping mode determined during step 504.

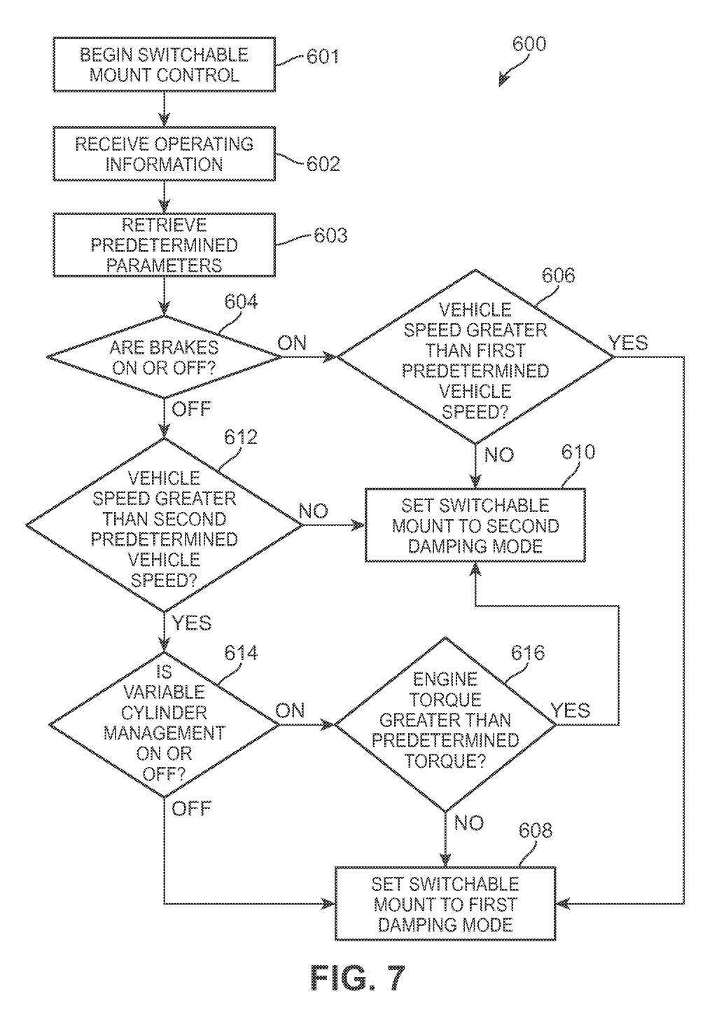

FIG. 7 is a flow chart illustrating an exemplary method 600 for controlling a vehicle suspension system switchable mount. As shown, the method 600 begins at step 601. Although FIG. 7 depicts step 601 as the start of method 600, it should be understood that method 600 may be an iterative process that continually runs while a vehicle is in operation, to monitor for changing operating conditions. Step 601 may commence when a vehicle engine is started and method 600 may be repeated at predetermined intervals, as necessary to detect changing vehicle operating conditions. In one exemplary implementation, method 600 is performed every 10 milliseconds, beginning when the vehicle is turned on and ending when the vehicle is turned off.

In one embodiment, a first damping mode for a vehicle suspension switchable mount may set the damping characteristics of the switchable mount to damp a lower frequency range, such as approximately 0-30 Hz. In other cases, the first damping mode may set the damping characteristics of the switchable mount to damp a frequency range of approximately 10-20 Hz. In some cases, the second damping mode for a vehicle suspension switchable mount may set the damping characteristics of the switchable mount to damp a higher frequency range, such as approximately 30-60 Hz. The control logic embodied in method 600 may switch the damping characteristics of the switchable mount between the first damping mode in which the control valve is positioned to direct fluid through the long flow channel 330 of switchable mount 110 (see FIG. 3) and the second damping mode in which the control valve is positioned to direct fluid through the short flow channel 332 of switchable mount 110 (see FIG. 4).

Following commencement of the method at step 601, in step 602, ECU 130 may receive vehicle operating information. This information can include any information from components 150, such as brake information, vehicle speed information, VCM system information, and engine torque information. In particular, in some cases, ECU 130 may receive a brake condition (i.e., brake ON or brake OFF), a value of the currently measured vehicle speed, a condition of the VCM system, and a currently measured engine torque value. In some cases, the condition or status of the VCM system may be a VCM ON or VCM OFF condition. In the VCM ON condition, it may be assumed that the engine is operating with less than the total number of available cylinders. In other cases, the status may be associated with the number of cylinders operating, for example, an engine with 6 cylinders could operate in a 4-cylinder mode or a 3-cylinder mode in addition to operating in a full 6-cylinder mode. In such a case, the VCM status could be 6-cylinder, 4-cylinder, or 3-cylinder.

Following step 602, in step 603, ECU 130 may retrieve one or more predetermined parameters. A predetermined parameter may be any type of stored value. Predetermined parameters could be set at manufacturing, or following manufacturing. In addition, predetermined parameters could be input by a manufacturer, a dealer, a user, or a mechanic. Furthermore, in some case, predetermined parameters could be determined by one or more vehicle systems. For example, a predetermined parameter could be a measured value of a vehicle parameter during a typical operating condition that is compared with values of the vehicle parameter at later times. Examples of predetermined parameters that could be retrieved from memory during step 603 include, but are not limited to, a first predetermined vehicle speed, a second predetermined vehicle speed, and a predetermined engine torque.

Next, in step 604, ECU 130 may determine if the brakes of the vehicle are being applied, i.e., whether the brakes are on. If the brakes are on, then ECU 130 continues to step 606, where ECU 130 determines whether the measured vehicle speed during braking is greater than a first predetermined vehicle speed. The first predetermined vehicle speed may be an approximate speed (or range of speeds) at which the vehicle exhibits a change in vibration sources during braking, such that above the first predetermined vehicle speed the vibration sources are associated with lower frequencies, and below the first predetermined vehicle speed the vibration sources are associated with higher frequencies. As one of ordinary skill in the art would appreciate, the first predetermined vehicle speed may depend upon factors such as the mass of the vehicle, the mass of the engine, the location of the engine within the vehicle, the components of the vehicle (e.g., the tires and suspension components), and the aerodynamics of the vehicle. The first predetermined vehicle speed may be established for a particular vehicle, for example, by theoretical vibration analyses or by empirical studies. The method for evaluating vehicle speed may account for hysteresis.

If, in step 606, the measured vehicle speed is greater than the first predetermined vehicle speed, then ECU 130 continues to step 608, at which point the switchable mount is switched to the first damping mode, if it is not already in that setting. In the first damping mode, the switchable mount may dampen vibrations associated with a lower frequency range, such as approximately 10-20 Hz. These lower frequency vibrations may be characteristic of the vehicle when the vehicle is braking and is traveling at a speed above the first predetermined vehicle speed.

If, in step 606, the measured vehicle speed is not greater than the first predetermined vehicle speed, then the method continues to step 610, at which point the switchable mount is switched to the second damping mode. In the second damping mode the switchable mount may dampen vibrations associated with a higher frequency range, such as approximately 30-60 Hz. These higher frequency vibrations may be characteristic of the vehicle when the vehicle is braking and is traveling at a speed below the first predetermined vehicle speed.

Returning to step 604, if it is determined that the brakes are not being applied, i.e., that the brakes are off, then the switchable mount compliance condition depends on additional factors as follows. If the brakes are off, ECU 130 continues to step 612 to evaluate vehicle speed. In step 612, if a measured vehicle speed is not greater than a second predetermined vehicle speed, then ECU 130 continues to step 610 at which point the switchable mount is set to the second damping mode.

The second predetermined vehicle speed may be an approximate speed (or range of speeds) at which the vehicle exhibits a change in vibration sources when the brakes are off, such that below the second predetermined vehicle speed the vibration sources are associated with higher frequencies, and above the second predetermined vehicle speed the vibration sources are associated with either higher or lower frequencies, depending on engine cylinder operation and engine torque. As one of ordinary skill in the art would appreciate, the second predetermined vehicle speed may depend upon factors such as the mass of the vehicle, the mass of the engine, the location of the engine within the vehicle, the components of the vehicle (e.g., the tires and suspension components), and the aerodynamics of the vehicle. The second predetermined vehicle speed may be established for a particular vehicle, for example, by theoretical vibration analyses or by empirical studies. The method for evaluating vehicle speed may account for hysteresis. Furthermore, in some embodiments, the second predetermined vehicle speed may be substantially different from the first predetermined vehicle speed. In some cases, the second predetermined vehicle speed may be less than the first predetermined vehicle speed. In other cases, the second predetermined vehicle speed may be greater than the first predetermined vehicle speed.

If, in step 612, the measured vehicle speed is greater than the second predetermined vehicle speed, then the switchable mount compliance condition depends on the status of the engine cylinder operation as follows. ECU 130 continues to step 614 to determine the status of a variable cylinder management (VCM) system.

Deactivating cylinders may change the vibration characteristics of the engine. ECU 130 therefore considers this factor in adjusting the switchable mount to dampen different frequency ranges of vibration. Thus, in step 614, if the VCM is off and all cylinders are active, then ECU 130 continues to step 608, at which point the switchable mount is set to the first damping mode, if it is not already in that setting. With the switchable in the first damping mode, the switchable mount may dampen vibrations associated with a lower frequency range, such as approximately 10-20 Hz. These lower frequency vibrations may be characteristic of the vehicle when the vehicle is not braking, is traveling at a speed above the second predetermined vehicle speed, and is operating on all cylinders (i.e., the VCM system is off).

Returning to step 614, if the VCM system is on, then the switchable mount compliance condition depends on engine torque. In this case, ECU 130 continues to step 616 to evaluate engine torque. In step 616, if a measured engine torque is above a predetermined torque, then ECU 130 continues to step 610, at which point the switchable mount is switched to the second damping mode, if it is not already in that setting. With the switchable in the second damping mode, the switchable mount may dampen vibrations associated with a higher frequency, such as approximately 30-60 Hz. These higher frequency vibrations may be characteristic of the vehicle when the vehicle is not braking, is traveling at a speed above the second predetermined vehicle speed, is operating on a reduced number of cylinders, and when the engine torque is above a predetermined engine torque. Evaluating engine torque may take into account hysteresis.

The predetermined engine torque may be an approximate torque (or range of torques) at which the vehicle exhibits a change in vibration sources (with no braking, with the vehicle traveling faster than the second predetermined vehicle speed, and with the VCM system on), such that above the predetermined engine torque the vibration sources are associated with higher frequencies, and below the predetermined engine torque the vibration sources are associated with lower frequencies. As one of ordinary skill in the art would appreciate, the predetermined engine torque may depend upon factors such as the mass of the vehicle, the mass of the engine, the location of the engine within the vehicle, and the components of the vehicle (e.g., the tires and suspension components). The predetermined engine torque may be established for a particular vehicle, for example, by theoretical vibration analyses or by empirical studies.

If, in step 616, a measured engine torque is below a predetermined torque, then ECU 130 continues to step 608, at which point the switchable mount is switched to the first damping mode, if it is not already in that setting. With the switchable mount in the first damping mode, the switchable mount may dampen vibrations associated with a lower frequency range, such as approximately 10-20 Hz. These lower frequency vibrations may be characteristic of the vehicle when the vehicle is not braking, is traveling at a speed above the second predetermined vehicle speed, is operating on a reduced number of cylinders, and when the engine torque is below a predetermined engine torque.

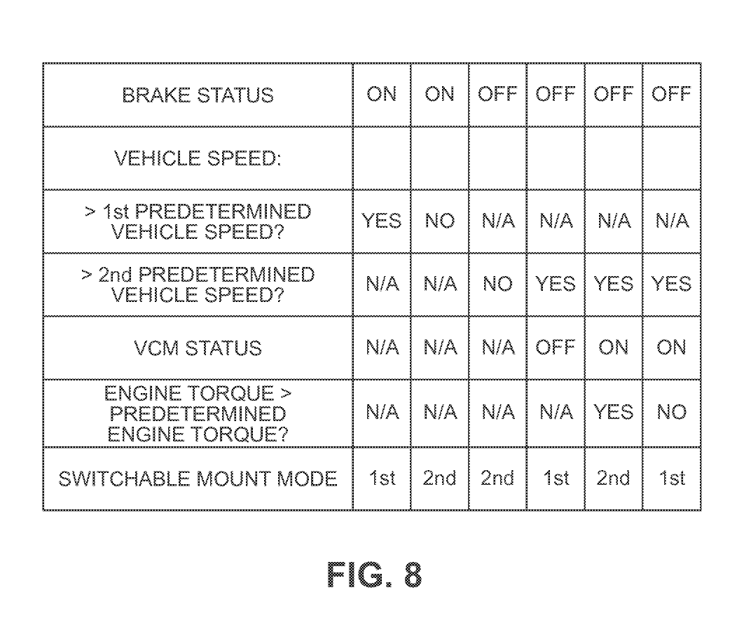

The table shown in FIG. 8 summarizes each of the different possible vehicle operating conditions and the switchable mount settings associated with each for one possible embodiment of the method. For example, whenever the brake is on and the vehicle speed is above the first predetermined vehicle speed, the switchable mount is set to the first damping mode. As another example, whenever the brake is on and the vehicle speed is below the first predetermined vehicle speed, the switchable mount is set to the second damping mode. Similarly, the remaining columns of the table show the operating mode according to the various other possible configurations of each of the operating parameters discussed above. It will be understood that the table shown in FIG. 8 generally illustrates the various possible results that may be obtained by following the process shown in FIG. 7.

As mentioned above, method 600 may be repeated at desired intervals to continually monitor the operating conditions of a vehicle and adjust the switchable mount compliance condition accordingly. Thus, once step 608 or step 610 of method 600 is reached, after a desired interval (e.g., 10 milliseconds), ECU 130 may start again at step 602. With each iteration, the method 600 may leave the switchable mount in the setting (i.e., the first damping mode or the second damping mode) determined by the previous iteration, and only change the setting when reaching a different end result (i.e., the first damping mode of step 608 or the second damping mode of step 610). Consequently, during operation of a vehicle, method 600 may be repeated many times without changing the setting of the switchable mount. The method 600 for controlling a vehicle suspension system switchable mount therefore provides a comprehensive control scheme that accounts for many vibration sources and adjusts the switchable mount compliance condition accordingly. The method 600 is thus able to tailor vibration damping to many different driving conditions.

In FIG. 7, method 600 is used to adjust a switchable mount damping mode based on whether a VCM system is on or off, applying the first mode if the VCM system is off or if the VCM system is on and the measured engine torque is below a predetermined engine torque, and applying the second mode if the VCM system is on and the measured engine torque is above the predetermined torque. In some cases, therefore, method 600 may apply the same logic to any reduced cylinder operation. In other cases, method 600 could be modified to apply different logic for different reduced cylinder modes.

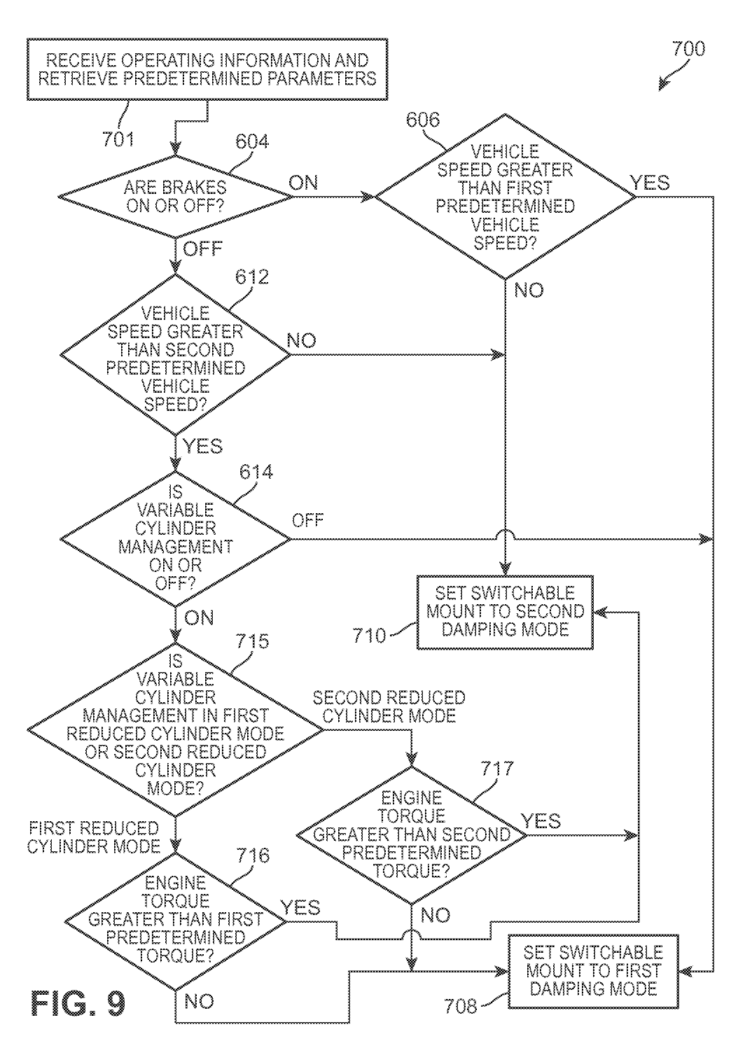

In another aspect, a method and system for controlling a switchable mount includes provisions for adjusting switchable mount compliance conditions for different modes of reduced cylinder engine operation. As one example, FIG. 9 illustrates a method 700 for controlling a switchable mount on an engine, which depends not only on braking conditions, vehicle speed, and engine cylinder operation, but also on the particular mode (e.g., number of cylinders) of the engine cylinder operation. As shown, method 700 applies different control logic for different modes of cylinder operation. In the current embodiment, the terms full cylinder mode, first reduced cylinder mode and second reduced cylinder mode are used to distinguish three different operating modes of an engine. For example, in one embodiment including a six cylinder engine: the full cylinder mode corresponds to a mode where all six cylinders are active; the first reduced cylinder mode refers to a mode where four cylinders are active and two cylinders are deactivated; and the third reduced cylinder mode refers to a mode where three cylinders are active and three cylinders are deactivated. However, in still other embodiments, any other numbers of cylinders may be activated during various different reduced cylinder modes.

Method 700 starts with step 701. In step 701, ECU 130 may receive operating information and also retrieve one or more predetermined parameters. In some cases, step 701 may proceed in a similar manner to steps 602 and 603 of method 600 (see FIG. 7). For example, in the current embodiment, ECU 130 may receive a vehicle speed, an engine torque, a brake status, and a variable cylinder management status. Also, ECU 130 may retrieve a first predetermined vehicle speed, a second predetermined that is different from the first predetermined vehicle speed, a first predetermined engine torque, and a second predetermined engine torque that is different than the second predetermined engine torque. Moreover, in some cases, the first predetermined vehicle speed may be less than the second predetermined vehicle speed. In other cases, the first predetermined vehicle speed could be greater than the second predetermined vehicle speed. Also, in some cases, the first predetermined engine torque may be less than the second predetermined engine torque. In other cases, the first predetermined engine torque may be greater than the second predetermined engine torque.

Likewise, step 604, step 606, step 612, and step 614 of method 700 of FIG. 9 follow substantially similar logic as like-numbered steps of method 600 of FIG. 7, as described above. (For brevity, the similar steps of FIG. 7 are not described again herein.) However, method 700 varies from method 600 in that method 700 applies different engine torque values for different modes of reduced cylinder operation, in this case as between a first reduced cylinder mode and a second reduced cylinder mode.

Picking up where method 700 differs from method 600, as shown in FIG. 9, at step 614, ECU 130 determines the status of the VCM system. If the VCM system is off, which in this case means the engine is operating in a full cylinder mode, then ECU 130 continues to step 708, at which point the switchable mount is set to the first damping mode. In the first damping mode, the switchable mount may dampen vibrations associated with a lower frequency range, such as approximately 10-20 Hz. These lower frequency vibrations may be characteristic of the vehicle when the vehicle is not braking, is traveling at a speed above the first predetermined vehicle speed, and is operating on all cylinders.

If, in step 614, ECU 130 determines that the VCM system is on, then the switchable mount compliance condition depends on the number of cylinders in operation and the engine torque relative to the number of operating cylinders. In step 715, ECU 130 determines the mode of operation of the VCM system. In one example, the modes of operation may be a three-cylinder mode (the second reduced cylinder mode) or a four-cylinder mode (the first reduced cylinder mode), each of which is associated with a different predetermined engine torque.

If, in step 715, it is determined that the VCM system is operating in a first reduced cylinder mode, ECU 130 continues to step 716 to evaluate the engine torque. If the measured engine torque is greater than a first predetermined engine torque, then ECU 130 continues to step 710, at which point the switchable mount is switched to the second damping mode. With the switchable mount set to the second damping mode, the switchable mount may dampen vibrations associated with a higher frequency, such as approximately 30-60 Hz. In some cases, these higher frequency vibrations may be characteristic of the vehicle when the vehicle is not braking, is traveling at a speed above the second predetermined vehicle speed, is operating in a reduced four-cylinder mode, and when the engine torque is greater than a first predetermined engine torque associated with the four-cylinder mode.

If, in step 716, the measured engine torque is not greater than the first predetermined engine torque, then ECU 130 continues to step 708, at which point the switchable mount is switched to the first damping mode, if it is not already in that setting. With the switchable mount set to the first damping mode, the switchable mount may dampen vibrations associated with a lower frequency range, such as approximately 10-20 Hz. These lower frequency vibrations may be characteristic of when the vehicle is not braking, is traveling at a speed above the second predetermined vehicle speed, is operating in a reduced four-cylinder mode, and when the engine torque is not greater than a first predetermined engine torque associated with the four-cylinder mode.

If, in step 715, it is determined that the VCM system is operating in a second reduced cylinder mode, as shown in FIG. 9, ECU 130 continues to step 717 to evaluate the engine torque. If the measured engine torque is greater than a second predetermined engine torque, then ECU 130 continues to step 710, where the switchable mount is set to the second damping mode, if it is not already in that setting. With the switchable mount in the second damping mode, the switchable mount may dampen vibrations associated with a higher frequency, such as approximately 30-60 Hz. These higher frequency vibrations may be characteristic of the vehicle when the vehicle is not braking, is traveling at a speed above the second predetermined vehicle speed, is operating in a reduced three-cylinder mode, and when the engine torque is greater than a second predetermined engine torque associated with the three-cylinder mode.

If, in step 717, the measured engine torque is not greater than the second predetermined engine torque, then ECU 130 continues to step 708, where the switchable mount is set to the first damping mode, if it is not already in that setting. With the switchable mount in the first damping mode, the switchable mount may dampen vibrations associated with a lower frequency range, such as approximately 10-20 Hz. These lower frequency vibrations may be characteristic of when the vehicle is not braking, is traveling at a speed above the second predetermined vehicle speed, is operating in a reduced three-cylinder mode, and when the engine torque is not greater than a second predetermined engine torque associated with the three-cylinder mode.

The first and second predetermined engine torques, which are associated with the first and second reduced cylinder modes, respectively, may be approximate torques (or ranges of torques) at which the vehicle exhibits a change in vibration sources (with no braking, with the vehicle traveling faster than the second predetermined vehicle speed, and with the VCM system on in the respective mode), such that above the predetermined engine torque the vibration sources are associated with higher frequencies, and below the predetermined engine torque the vibration sources are associated with lower frequencies. As one of ordinary skill in the art would appreciate, the first and second predetermined engine torques may depend upon factors such as the mass of the vehicle, the mass of the engine, the location of the engine within the vehicle, and the components of the vehicle (e.g., the tires and suspension components). The first and second predetermined engine torques may be established for a particular vehicle, for example, by theoretical vibration analyses or by empirical studies.

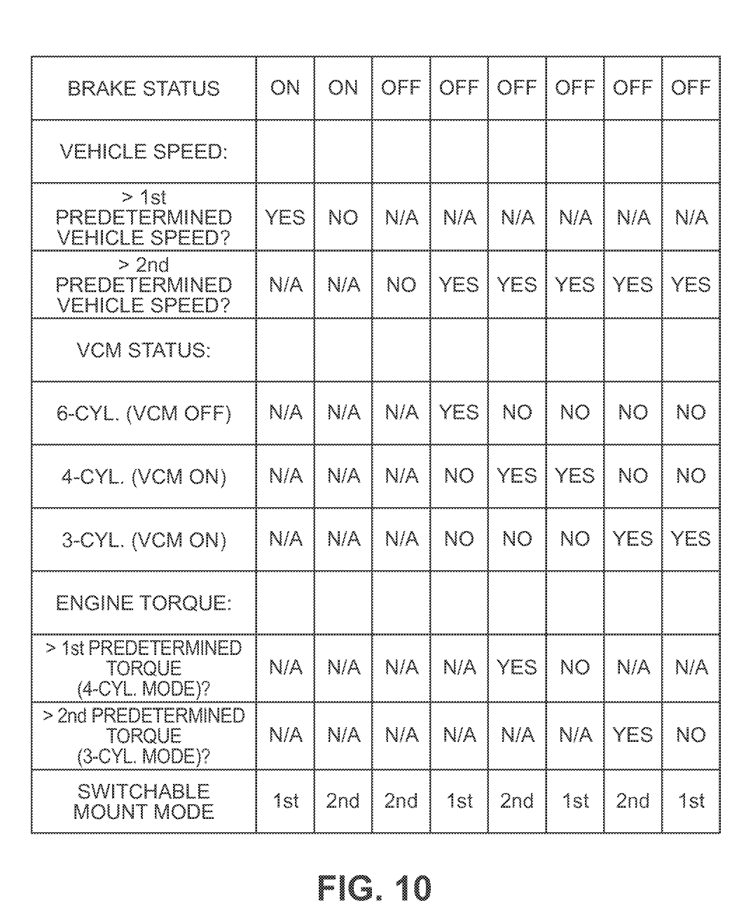

The table shown in FIG. 10 summarizes each of the different possible vehicle operating conditions and the switchable mount settings associated with each for one possible embodiment of the method. For example, whenever the brake is on and the vehicle speed is above the first predetermined vehicle speed, the switchable mount is set to the first damping mode. As another example, whenever the brake is on and the vehicle speed is below the first predetermined vehicle speed, the switchable mount is set to the second damping mode. Similarly, the remaining columns of the table show the operating mode according to the various other possible configurations of each of the operating parameters discussed above. It will be understood that the table shown in FIG. 10 generally illustrates the various possible results that may be obtained by following the process shown in FIG. 9.

A method of controlling a switchable mount can include provisions for varying the damping mode of the mount over multiple different speed ranges, in order to facilitate damping of the dominant sources of vibrations. For example, NVH vibrations may be worse than shimmy/judder vibrations at low vehicle speeds and high vehicle speeds, while shimmy/judder vibrations may dominate NVH vibrations at intermediate speeds. In such cases, a method for controlling a switchable mount can include two or more predetermined vehicle speeds that determine a set of distinct vehicle speed ranges where different types of vibrations may be dominant. In one embodiment, a method for controlling a switchable mount can include three or more predetermined vehicle speeds that determine four distinct ranges of vehicle speed where different types of vibrations are dominant.

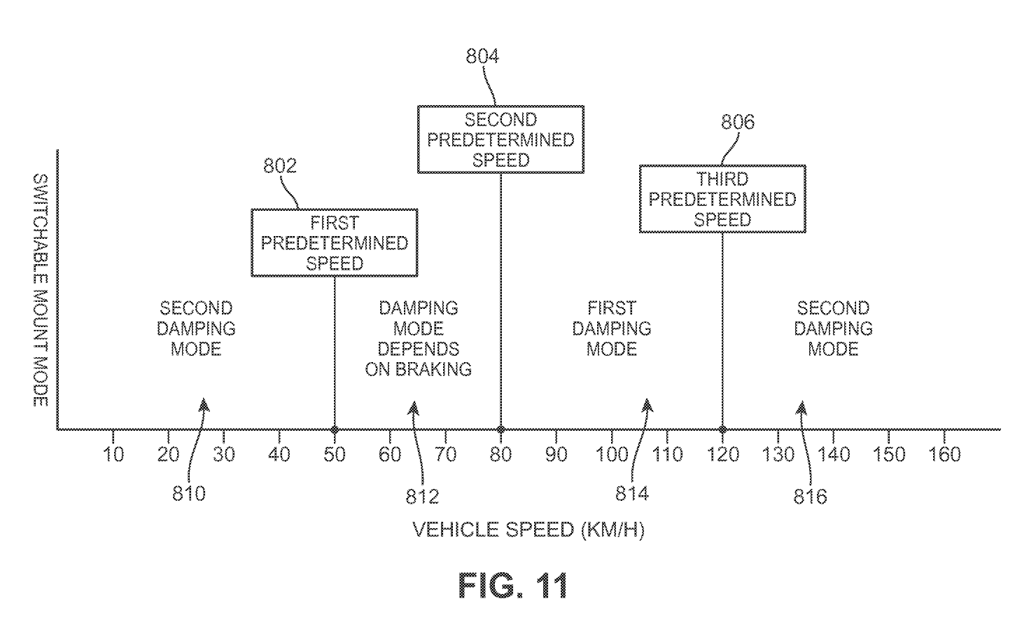

FIG. 11 is a schematic view of one embodiment of a set of four different speed ranges that are considered in controlling a switchable mount. In this embodiment, the system uses four distinct vehicle speed ranges including first speed range 810, second speed range 812, third speed range 814, and fourth speed range 816. First speed range 810 and second speed range 812 are separated by first predetermined speed 802. Second speed range 812 and third speed range 814 are separated by second predetermined speed 804. Also, third speed range 814 and fourth speed range 816 are separated by third predetermined speed 806.

For purposes of illustration, first predetermined speed 802 is indicated as 50 km/hour, second predetermined speed 804 is indicated as 80 km/h and third predetermined speed 806 is indicated as 120 km/hour. However, it should be understood that these are only exemplary speeds and in other embodiments first predetermined speed 802, second predetermined speed 804, and third predetermined speed 806 could have any other values or ranges of values.

In one embodiment, first speed range 810, including speeds between 0 km/hour and approximately 50 km/hour, is associated with the second damping mode for a switchable mount. The second damping mode is a high frequency damping mode that may help reduce NVH vibrations that tend to be more dominant than shimmy and/or judder vibrations at these relatively low vehicle speeds. In one embodiment, second speed range 812, including speeds between approximately 50 km/hour and approximately 80 km/hour, may be associated with either the first damping mode or the second damping mode of the switchable mount. In particular, when a vehicle travels at a speed approximately within second speed range 812, NVH vibrations may dominate shimmy and/or judder vibrations unless a vehicle is braking, in which case the shimmy and/or judder vibrations may dominate the NVH vibrations. Therefore, second speed range 812 is associated with the second damping mode (high frequency mode) while a vehicle is not braking, and the first damping mode (low frequency mode) while the vehicle is braking. In one embodiment, third speed range 814, including speeds between approximately 80 km/hour and approximately 120 km/hour, may be associated with the first damping mode. In some cases, the first damping mode is a low frequency damping mode that helps to dampen steering shake from shimmy and/or judder vibrations at higher vehicle speeds. In one embodiment, fourth speed range 816, including speeds above approximately 120 km/hour, may be associated with the second damping mode. In some cases, the second damping mode is a high damping mode. Although steering shake from shimmy and/or judder vibrations may be worse than NVH vibrations at higher vehicle speeds, at these higher vehicle speeds the higher frequency damping provided by the second damping mode may be better for reducing shimmy and/or judder vibrations at these relatively high vehicle speeds.

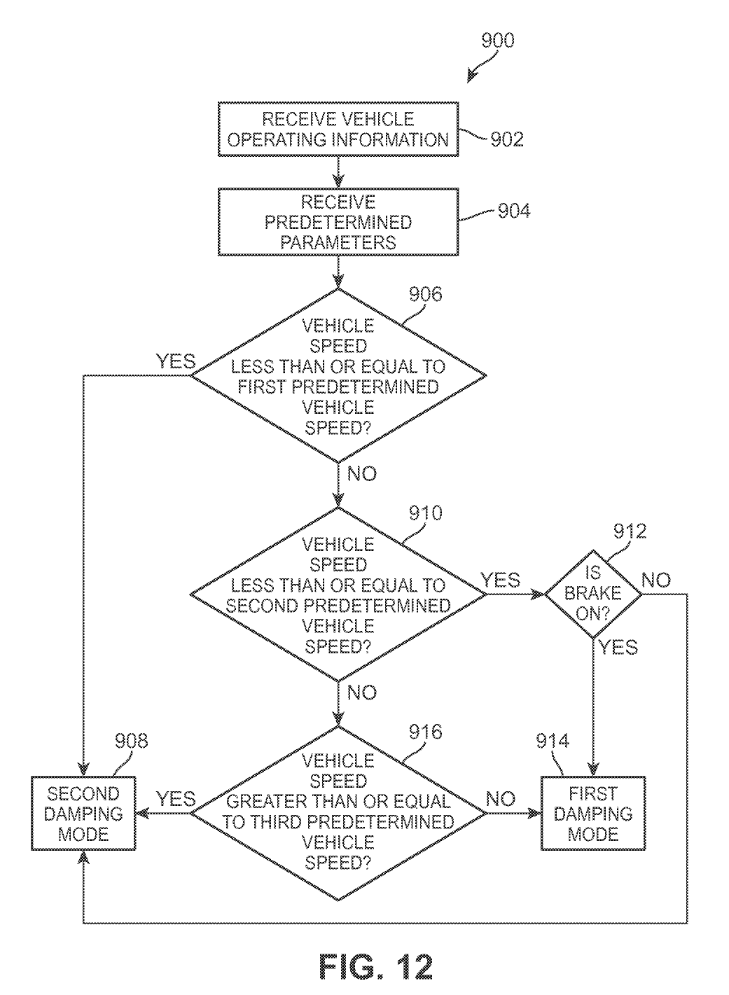

FIG. 12 illustrates an embodiment of a process for controlling a switchable mount system. In some embodiments, some of the steps associated with this process could be accomplished by switchable mount system 102 of a motor vehicle. In some cases, some of the steps may be accomplished by an ECU 130 of a motor vehicle. In other embodiments, some of the steps could be accomplished by other components of a motor vehicle. In still other embodiments, some of the steps could be accomplished by any combination of systems or components of the vehicle. It will be understood that in some embodiments one or more of the steps associated with the process may be optional. For purposes of reference, the following method discusses components shown in FIG. 1, including components 150.

In one embodiment, the first damping mode and the second damping mode may correspond to a low frequency mode and a high frequency mode, respectively. For example, in some cases, the first damping mode could be configured to damp vibrations below approximately 30 Hz. In one embodiment, the first damping mode could be configured to damp vibrations approximately in the range between 10 Hz and 20 Hz. Also, the second damping mode could be configured to damp vibrations greater than 30 Hz. In some cases, the second damping mode could be configured to damp vibrations approximately in the range between 30 Hz and 100 Hz. In some cases, the second damping mode could be configured to damp vibrations approximately in the range between 30 Hz and 60 Hz. In other cases, however, the first damping mode and the second damping mode could be associated with any other ranges of frequencies. Moreover, in still other cases, the first damping mode could be a high frequency damping mode, while the second damping mode could be a low frequency damping mode.

Method 900 begins at step 902, where ECU 130 may receive vehicle operating information. In some cases, the vehicle operating information can include brake information, vehicle speed information, VCM system information, and engine torque information. In some cases, ECU 130 may not receive VCM information during step 902.

Although FIG. 12 depicts step 902 as the start of method 900, it should be understood that method 900 may be an iterative process that continually runs while a vehicle is in operation, to monitor for changing operating conditions. Step 902 may commence when a vehicle engine is started and method 900 may be repeated at predetermined intervals, as necessary to detect changing vehicle operating conditions. In one exemplary implementation, method 900 is performed every 10 milliseconds, beginning when the vehicle is turned on and ending when the vehicle is turned off.

Following step 902, in step 904, ECU 130 may retrieve one or more predetermined parameters. A predetermined parameter may be any type of stored parameter. Predetermined parameters could be set at manufacturing, or following manufacturing. In addition, predetermined parameters could be input by a manufacturer, a dealer, a user, or a mechanic. Furthermore, in some case, predetermined parameters could be determined by one or more vehicle systems. For example, a predetermined parameter could be a measured value of a vehicle parameter during a typical operating condition that is compared with values of the vehicle parameter at later times. Examples of predetermined parameters that could be retrieved from memory during step 904 include, but are not limited to, a first predetermined vehicle speed, a second predetermined vehicle speed, and a third predetermined vehicle speed.

In step 906, ECU 130 determines whether the measured vehicle speed during braking is less than or equal to a first predetermined vehicle speed. In one embodiment, the first predetermined speed may be approximately 50 km/hour. If, in step 906, the measured vehicle speed is less than or equal to the first predetermined vehicle speed, then ECU 130 continues to step 908 where the switchable mount is set to the second damping mode. In some cases, the second damping mode is a high frequency damping mode. This allows the switchable mount to damp NVH vibrations that may be dominant at vehicle speeds below the first predetermined vehicle speed, which may be a relatively low vehicle speed. If, during step 906, ECU 130 determines that the measured vehicle speed is greater than the first predetermined vehicle speed, ECU 130 proceeds to step 910.

At step 910, ECU 130 determines if the measured vehicle speed is less than or equal to the second predetermined vehicle speed. If so, ECU 130 proceeds to step 912. In step 912, ECU 130 determines if the brake is on. In the range of speeds between the first predetermined vehicle speed and the second predetermined vehicle speed, the dominant source of vibrations may depend on the braking condition of the vehicle (i.e., if the brake is ON or OFF). If, in step 912, ECU 130 determines that the brake is not on, ECU 130 may proceed to step 908 where the switchable mount is set to the second damping mode. In particular, this allows for high frequency damping to counter the higher frequency vibrations present in this particular speed range when the brake is not being applied. If, in step 912, ECU 130 determines that the brake is on, ECU 130 may proceed to step 914. In particular, this allows for low frequency damping to counter low frequency vibrations that are dominant in this speed range when the brake is applied.

Returning to step 910, if ECU 130 determines that the measured vehicle speed is not less than or equal to the second predetermined speed, ECU 130 proceeds to step 916. In step 916, ECU 130 may determine if the measured vehicle speed is greater than or equal to a third predetermined speed. If the measured speed is greater than or equal to the third predetermined speed, ECU 130 may proceed to step 908. Otherwise, ECU 130 may proceed to step 914.

As one of ordinary skill in the art would appreciate, each predetermined vehicle speed may depend upon factors such as the mass of the vehicle, the mass of the engine, the location of the engine within the vehicle, the components of the vehicle (e.g., the tires and suspension components), and the aerodynamics of the vehicle. Each predetermined vehicle speed may be established for a particular vehicle, for example, by theoretical vibration analyses or by empirical studies.

While various embodiments have been described, the description is intended to be exemplary, rather than limiting and it will be apparent to those of ordinary skill in the art that many more embodiments and implementations are possible. Accordingly, the embodiments are not to be restricted except in light of the attached claims and their equivalents. Also, various modifications and changes may be made within the scope of the attached claims.

What is claimed is:

1. A method for controlling a switchable mount in a motor vehicle, comprising:
receiving a vehicle speed;
receiving an engine torque;
receiving a brake status;
receiving a variable cylinder management operating mode;
retrieving a predetermined engine torque;
retrieving a predetermined vehicle speed;
comparing the vehicle speed with the predetermined engine speed;
comparing the engine torque with the predetermined engine torque;
switching the switchable mount between a first damping mode and a second damping mode according to the brake status, the variable cylinder management operating mode, the comparison of the vehicle speed with the predetermined engine speed, and the comparison of the engine toque with the predetermined engine torque; and
wherein the first damping mode and the second damping mode are configured to damp substantially different ranges of frequencies.

2. The method according to claim 1, wherein the first damping mode is configured to damp lower frequencies than the second damping mode.

3. The method according to claim 1, wherein the first damping mode is associated with frequencies approximately in the range between 0 Hz and 30 Hz.

4. The method according to claim 3, wherein the first damping mode is associated with frequencies approximately in the range between 10 Hz and 20 Hz.

5. The method according to claim 1, wherein the second damping mode is associated with frequencies approximately in the range between 30 Hz and 60 Hz.

6. The method according to claim 5, wherein the second damping mode is associated with frequencies approximately in the range between 40 Hz and 50 Hz.

7. The method according to claim 1, wherein the predetermined vehicle speed is a first predetermined vehicle speed, and wherein the method includes retrieving a second predetermined vehicle speed.

8. The method according to claim 7, wherein switching between the first damping mode and the second damping mode includes comparing the vehicle speed with the first predetermined vehicle speed and the second predetermined vehicle speed.

9. The method according to claim 1, wherein the variable cylinder operating mode is associated with a full cylinder mode, a first reduced cylinder mode and a second reduced cylinder mode, the second reduced cylinder mode being different than the first reduced cylinder mode.

10. The method according to claim 9, wherein the predetermined engine torque is a first predetermined engine torque and wherein the method includes retrieving a second predetermined engine torque that is different from the first predetermined engine torque.

11. The method according to claim 10, wherein switching between the first damping mode and the second damping mode includes comparing the engine torque with the first predetermined engine torque when the vehicle is operating in the first reduced cylinder mode and comparing the engine torque with the second predetermined engine torque when the vehicle is operating in the second reduced cylinder mode.

12. The method according to claim 1, wherein the first damping mode is associated with at least one of shimmy vibrations and judder vibrations.

13. The method according to claim 1, wherein the second damping mode is associated with noise, vibration, and harshness.

14. A method for controlling a switchable mount in a motor vehicle, comprising:
receiving a vehicle speed;
retrieving a first predetermined vehicle speed and a second predetermined vehicle speed, the second predetermined vehicle speed being greater than the first predetermined vehicle speed;
comparing the vehicle speed with the first predetermined vehicle speed;
comparing the vehicle speed with the second predetermined vehicle speed;
switching the switchable mount between a first damping mode and a second damping mode according to the comparison of the vehicle speed with the first predetermined vehicle speed and the second predetermined vehicle speed; and
wherein the first damping mode and the second damping mode are configured to damp substantially different ranges of frequencies.

15. The method according to claim 14, wherein switching the switchable mount includes switching the switchable mount to the second damping mode when the vehicle speed is less than the first predetermined vehicle speed.

16. The method according to claim 14, wherein the method includes retrieving a third predetermined vehicle speed that is greater than the second predetermined vehicle speed.

17. The method according to claim 16, wherein switching the switchable mount includes switching the switchable mount to the first damping mode when the vehicle speed is between the second predetermined vehicle speed and the third predetermined vehicle speed.

18. The method according to claim 17, wherein switching the switchable mount includes switching the switchable mount to the second damping mode when the vehicle speed is above the third predetermined vehicle speed.

19. The method according to claim 16, wherein the method includes receiving braking information and wherein switching the switchable mount includes:
switching the switchable mount to the first damping mode when the vehicle speed is between the first predetermined vehicle speed and the second predetermined vehicle speed and the brake is on; and
switching the switchable mount to the second damping mode when the vehicle speed is between the first predetermined vehicle speed and the second predetermined vehicle speed and the brake is off.

20. A switchable mount system for a motor vehicle, comprising:
an electronic control unit configured to receive vehicle speed information, variable cylinder management information, engine torque information, and braking information;
a switchable mount configured to operate in a first damping mode and a second damping mode;
wherein the electronic control unit is configured to change the switchable mount between the first damping mode and the second damping mode using the vehicle speed information, the variable cylinder management information, the engine torque information, and the braking information; and
wherein the first damping mode and the second damping mode are substantially different.

21. The switchable mount system according to claim 20, wherein the switchable mount is a hydraulic bushing.

22. The switchable mount system according to claim 20, wherein the switchable mount is configured for a vehicle suspension system.

23. The switchable mount system according to claim 20, wherein the first damping mode is a relatively low frequency damping mode, and wherein the second damping mode is a relatively high frequency damping mode.

24. The switchable mount system according to claim 23, wherein the first damping mode is associated with frequency ranges between approximately 0 Hz and 30 Hz.

25. The switchable mount system according to claim 23, wherein the second damping mode is associated with frequencies approximately in the range between 30 Hz and 60 Hz.

26. A motor vehicle, comprising:
a component of a vehicle suspension system;
a fluid-filled suspension bushing attached to the component of the vehicle suspension system; and
wherein the suspension bushing is configured to damp vibrations having frequencies approximately in the range between 30 Hz and 60 Hz.

27. The motor vehicle according to claim 26, wherein the suspension bushing is tuned to damp vibrations due to engine vibrations when an engine of the motor vehicle is operating in a reduced cylinder mode.

28. The motor vehicle according to claim 26, wherein the suspension bushing is tuned to damp vibrations associated with noise, vibration, and harshness.

29. The motor vehicle according to claim 26, wherein the suspension bushing is tuned to damp vibrations approximately in the range between 40 Hz and 50 Hz.

30. A switchable mount system for a motor vehicle, comprising:
an electronic control unit;
a switchable mount configured to operate in a first damping mode and a second damping mode;
wherein the electronic control unit is configured to change the switchable mount between the first damping mode and the second damping mode; and
wherein the first damping mode is configured to damp vibrations having frequencies in the range between approximately 0 Hz to 30 Hz and wherein the second damping mode is configured to damp vibrations having frequencies in the range approximately between 30 Hz to 60 Hz.

31. The switchable mount system according to claim 30, wherein the electronic control unit is configured to receive vehicle speed information, engine torque information, and braking information, and wherein the electronic control unit is configured to switch the switchable mount between the first damping mode and the second damping mode according to the vehicle speed information, the engine torque information, and the braking information.

32. The switchable mount system according to claim 30, wherein the electronic control unit is configured to receive variable cylinder management information, and wherein the electronic control unit is configured to switch the switchable mount between the first damping mode and the second damping mode according to the variable cylinder management information.

33. The switchable mount system according to claim 30, wherein the first damping mode is configured to damp vibrations associated with at least one of shimmy vibrations and judder vibrations.

34. The switchable mount system according to claim 30, wherein the second damping mode is configured to damp vibrations associated with noise, vibration, and harshness.
